(19) United States
(12) Patent Application Publication
(10) Pub. No.: US 2022/0245370 A1
(43) Pub. Date: Aug. 4, 2022

(54) Image-based Method for Monitoring Stored Items

(71) Applicant: David Sean Kehoe, Jersey City, NJ (US)

(72) Inventor: David Sean Kehoe, Jersey City, NJ (US)

(21) Appl. No.: 17/588,246

(22) Filed: Jan. 29, 2022

Related U.S. Application Data
(60) Provisional application No. 63/144,035, filed on Feb. 1, 2021.

(51) Int. Cl. G06K 7/10; H04N 5/232; G06K 7/14

(52) U.S. Cl. CPC G06K 7/10722; G06K 7/1413; H04N 5/23293

(57) ABSTRACT

A method using image-based tags to monitor items stored in a container, and to use information extracted from an image of the container to monitor the contents and the introduction, arrangement, rearrangement, and removal of tagged items from a container.

### CROSS REFERENCE

The present application claims priority to the earlier filed Provisional Application No. 63/144,035, and hereby incorporates subject matter of the provisional application in its entirety.

### BACKGROUND

Computer systems can monitor physical items (such as keys, access cards, medicines, and other valuables) that are in a container in order to know what items are present and, by inference, what items have been added or removed. For example, large apartment complexes use systems to track the issuance and return of apartment door keys from a secure storage container. These systems often use a drawer-style container to hold traditional keys attached to a fob containing a computer chip, with the chip having a computer-readable, unique ID number. If the container is breached or if a key and fob are lost while outside of the container, the keys can only be identified by use of the computer system. These systems are expensive and complex because they rely on electro-mechanical methods to read the computer chip, to record the location of each fob in the drawer's matrix, and to indicate which fob is being requested. In addition, these systems are often too large for where the operator is stationed and thus necessitate the operator leaving their post to go to the system in a separate area in order to extract or return a key.

### SUMMARY OF THE INVENTION

The present invention simplifies the monitoring process and it also allows for high density storage of small items, thus making monitoring more cost effective and easier to use for many applications. It accomplishes this by using an image processing approach that captures an image of the contents of a container and then processes this image to identify the items and their location within the container. The present invention can be implemented with a simple box for a container and a commonly available, low-cost smartphone.

To simplify recognition of items, the present invention uses a tag with an image pattern ID (“Identifying Image”) on each item, with the Identifying Images arranged so that all of them are visible from a single vantage point. Examples of Identifying Images are bar codes, UPC labels, and QR codes. When the objective is to track specific items (such as a key to a particular apartment), the Identifying Images are unique. When the objective is to track the quantity of a specific type of object (e.g., the number of boxes of bandages) in the container, the Identifying Images only need to be unique to the type (e.g., the UPC code of a product).

When security of the items is important, a locking container cover or door secures the contents while allowing the Identifying Images on the contents to remain visible. Where an item does not lend itself to being positioned in the container so that its Identifying Image is visible, a tag with an Identifying Image can be attached to the item and the tag put into a readable position.

To inventory the items in the container, a single image of the container is analyzed to decode and record all of the Identifying Images present. Using a cross-reference table, the system translates these Identifying Images into a list of Items stored in the container.

To track changes in the contents of the container, the present invention compares a prior image (in some uses, from after the container was last locked) with an image captured after the contained Items may have been changed (such as after an item has been removed and the container re-locked). This comparison reveals if any Identifying Images (and thus, by inference their associated Items) have been added, moved, or removed from the container.

To retrieve a specific item from within the container, the operator enters a reference to the desired Item (e.g., ‘Key for 3602’) into a device, typically a handheld smartphone. The device analyzes a stream of images of the container collected in real time to determine the location of the item's Identifying Image relative to the handheld device. This directional information is presented as an overlay of the image of the container to guide the operator to the location of the Identifying Image associated with that item.

By using image analysis and a commonly available smart phone for capturing and analyzing images, all electronics required to identify, inventory, and track movement in, out, and around the container are eliminated from the system, thereby reducing the cost and increasing the reliability over alternative methods.

By positioning the item behind an attached Identifying Image, items with two small dimensions (e.g., a key) can be put closely together and thus use the depth of the container to use increase the storage density of the container.

### BRIEF DESCRIPTION OF DRAWINGS

FIG. 1 shows a Remote Controller hovering above a Container to show its position relative to a Container when capturing image(s).

FIG. 2 shows the embodiment of the attachment features of the Container and an enclosed Electronics Unit.

FIG. 3 shows an embodiment of a secure Container, Alignment Matrix, and a hinged Cover designed for Items that employ a tag holder for holding the Identifying Images.

FIG. 4 shows a close-up of an embodiment using the Alignment Matrix for holding a key.

### DETAILED DESCRIPTION OF DRAWINGS

The examples referred to herein are illustrative and are not to be regarded as limiting the scope of the invention.

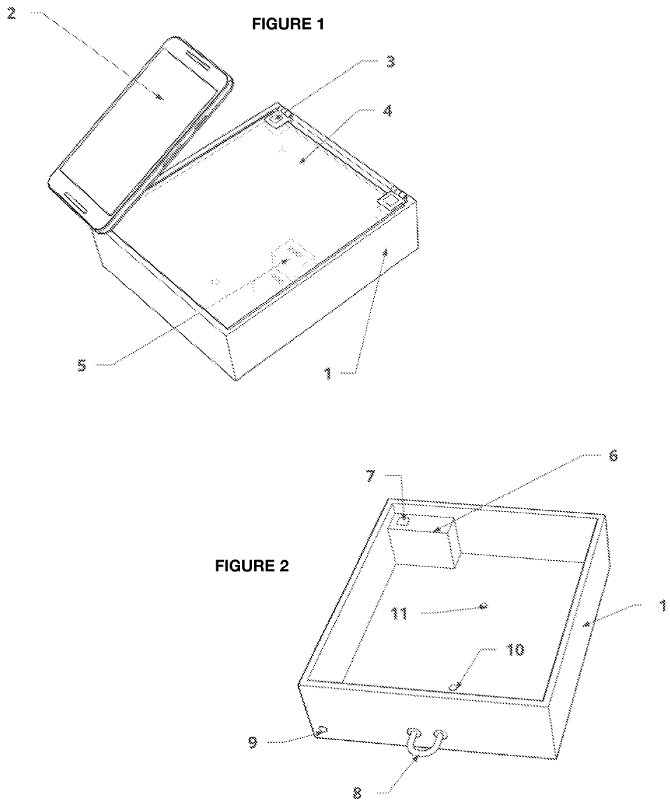

FIG. 1 is an embodiment of a typical Remote Controller 2 and a typical position relative to Container 1 when 1 is mounted to a desktop or in a drawer. 3 is an Identifying Image (required if there is not an Electronics Unit inside the unit as is shown in FIG. 2) on the surface of the hinged Cover that identifies the Container and orients the image captured by 2. 3 can also be used to identify the outline of the container based on the known ratio of the dimensions of the Identifying Image to that of the Container. 4 is a translucent cover that protects the contents 5, each of which has a Identifying Image in this embodiment in the form of a bar code. Another embodiment would be to use an opaque cover with openings large enough to reveal the Identifying Images but small enough to prevent the items from being removed.

FIG. 2 shows an embodiment of a container 1 shown without a cover. Inside 1, is an Electronics Unit 6 with an Identifying Image 7 for identification. The Identifying Image can also be used to identify the outline of the container based on the known ratio of the dimensions of the Identifying Image to that of the container. Contained in 6 are a computer processor; interface components need to communicate with the Remote Controller and the electro-mechanical lock for the Cover; and the Cover lock mechanism itself. In case of a component failure, 6 is replaceable, with all of the electro-mechanical parts in a single part. 9 is an opening at the rear of 1 to allow a power/communications cable to travel between 6 and the outside of 1. U-bolt 8, positioned on the rear side of 1, allows a lock's shaft or cable to pass through the exposed end of the u-bolt and connect with a secure attachment point external to 1. Holes 10 and 11 allow bolting 1 to the surface on which 1 rests (for example, a desktop or drawer bottom, or a wall if 1 is used in a vertical position).

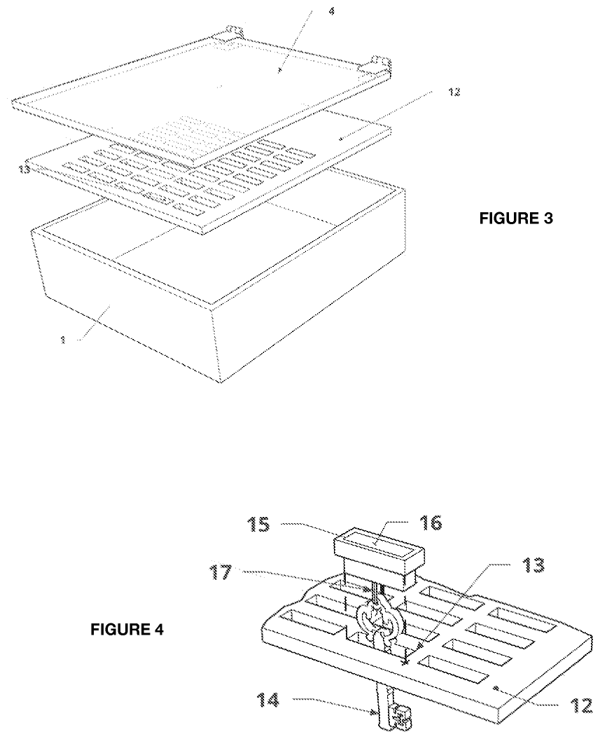

FIG. 3, an exploded view, shows an embodiment of a Container 1 and translucent Cover 4. This embodiment is designed for items that employ a tag holder for holding the Identifying Images and uses an Alignment Matrix 12 to align hold the tag holders in alignment (see FIG. 4 for a detailed view) to allow the Identifying Images to be properly oriented regardless of the orientation of the attached item(s). FIG. 3 shows one possible design for 12, but the size, number, location, and orientation of openings 13 is unrestricted.

FIG. 4 depicts a close up of the corner of an embodiment of the Alignment Matrix 12 (with the Container and Cover in FIG. 3 hidden from view) used for securely storing door keys. Because the shape of item 14 prevents it from being tagged with a Identifying Image directly and because presenting the top side of the key to the camera allows for the most space-efficient arrangement, 14 is attached via a flexible connector 17 to a tag holder 15 that has an Identifying Image 16 on its top surface. The figure shows the partial insertion of 14 through opening 13. The openings may be of any size and shape and may vary in size and shape within a single Alignment Matrix; the only requirement is that the horizontal dimensions of each opening must exceed the respective dimensions of the item 9 so that the item will pass through 13. Similarly, at least one dimension of 15 must exceed that of the respective dimension of the 13; this is to prevent 15 from passing through the 13. In addition, 15 has a lower portion whose horizontal measurements are at least minimally less than the respective measurements of the 13 in order to enable 15 to rest inside of 13 in the desired alignment, if desired.

### DETAILED DESCRIPTION OF THE INVENTION

The invention comprises the following parts and/or methods, none of which is individually novel unless noted and may be partially or in whole employed as a part of a complete method for existing purposes such as key monitoring as well as for novel purposes, comprising:
1. Any object (“Item”) that the operator desires to monitor in a container. A door key is an example of an Item. Items can be of any and differing sizes or composition. Multiple objects (such as the corresponding top and bottom lock keys) can be bound together and assigned a single identifier and monitored as a single Item. The invention allows for an unlimited number of Items.
2. “Identifying Images” that are unique and correspond to the Items to be monitored. The Identifying Images may be affixed to, printed on, or incorporated in the Item so that the entire Identifying Image is visible from the camera vantage point; or they can be attached to or made a part of a device (“Tag Holder”) for holding an Identifying Image that is then attached to the item, with this latter arrangement allowing the Item to be suspended from or positioned behind the Tag Holder. Specifically:
   (A) Identifying Images may be of various size and shape, with the only requirements being that they are machine-readable from a distance necessary to capture the contents of the entire container in a single image. The Identifying Image does not have to be flat if the encoding method is able to compensate for the shape.
   (B) Any encoding method (such as bar codes and QR codes) may be used provided that Identifying Image can be read from any orientation and an angle satisfactory to the application. However, when an encoding method has a decoding method widely available (such as barcodes and QR codes), at least one intermediary encoding step such as a private lookup table should be used to prevent unauthorized people from decoding the Identifying Image. More than one encoding method can be used within the Container. Which method chosen will depend on the shape of the Items or (if using a tag holder—see below), the shape of the tag holder; for example, QR codes are square or circular whereas a bar code is rectangular.
   (C) If the operator's intent is to track individual items, the Identifying Image must be unique in its sphere of use (e.g., a particular geographic location). If the operator's intent is to track the quantities of individual types of items and not specific Items themselves, the Identifying Images must be unique to each type but the same Identifying Image may appear multiple times, once for each Item of the same type in the container.
   (D) The Identifying Image is positioned on the Item so that all Identifying Images are visible from a single vantage point. If an opaque Cover (defined below) is used, the Identifying Image must be visible through openings in the Cover from vantage points that are not strictly normal (i.e., not perpendicular to the Cover). As an alternative to directly affixing, printing, or making the Identifying Image a part of the Item:
      (i) Placing the Item into its own container (e.g., a box) with an Identifying Image. If desired, this individual container may employ a tamper indicator, such as a safety seal.
      (ii) Attaching some kind of a tag holder (e.g., a key fob) to the Item and labelling the tag holder. The link between the tag holder and the Item may also have a tamper indicator to indicate if the Item has been disassociated from the tag holder, and thus from the Identifying Image.
3. At least one “Container”, which is a physical container of a fixed and known shape that holds Items and (if used) their tag holders. Optionally, a door, cover, or other lockable mechanism (“Cover”) that prevents the items in the Container from being removed when closed (thus making the Container secure), and when open, allows access to the Items for adding, moving, or removing them. The Cover must be such that it permits viewing the Identifying Images in the Container from a single vantage point regardless of whether it is open or closed. The Cover can be locked and unlocked by an electronic latching mechanism operated remotely (wirelessly by BlueTooth, WiFi, or otherwise) or by direct connection. Sensors in the Container report through one of the means of communications just described if the Cover is closed and latched.

In some cases, the Container may include partitions for separating items from others and otherwise making for a neat arrangement of the contents. The size and shape of the partitions if used are irrelevant, unless the encoding method of the Identifying Image requires that the Identifying Image be at a fixed location and/or orientation.

The size of the Container is governed by the size of the Identifying Images, the desired distance to the image capture vantage point, and the focal length and resolution of the device capturing the image. The captured image must include the entire Container and be of sufficient clarity to reliably decode the Identifying Images. For additional capacity, multiple Containers can be used, but the locking and image capture remain on a per-container basis.
4. A novel “Electronics Unit”, typically within the Container, which itself contains a computer processor and associated equipment for (i) communicating directly (such as via USB) or wirelessly (such as WiFi or Bluetooth), and (Identifying Image) controlling the electronic lock for locking and unlocking the Cover if a secure container is desired. The computer processor contains non-volatile storage for the recording the contents of the Container. The Electronics Unit has a visible Identifying Image, which is used to identify the Electronics Unit and the Container, and it is used by the image processor to orient the image. Because the electronics contained in the Electronics Unit are minimal, the Electronics Unit can be operated from a battery or external power source, such as a standard USB connection.
5. If the item's Identifying Images are affixed to tag holders, a “Tag Holder Matrix” keeps the Identifying Images orderly, irrespective of the orientation of the associated Items. The Tag Holder Matrix has one opening per Item location. The openings can be in any shape, position, and size (including different shapes and sizes within the same Tag Holder Matrix) provided that:
   (A) If required by the encoding method, the location of the openings in the Tag Holder Matrix is fixed
   (B) The size of the opening has to be at least as large as the size of the Item (or the Item's package, if used) to permit the Item to pass through the Tag Holder Matrix. One dimension of the Tag Holder that is perpendicular to the direction of travel when inserting and removing Items (i.e., width or height but not depth) must be larger than the respective measurement of the opening in the Tag Holder Matrix to prevent the Tag Holder from passing through the Tag Holder Matrix, and the lower portion of the Tag Holder must be at least minimally smaller than the size of the opening to allow the Tag Holder to fit in place.
6. A device (“Remote Controller”) that communicates with the Container's processor and provides the operator's interface to the system; provides a communication relay link to a host; performs image capture with sufficient pixel resolution, image sharpness, and exposure adjustment to allow for the capture of a digital image of the Container suitable for later analysis; image analysis; and fingerprint recognition or password entry. The Remote Controller may be a standard smartphone that yields an image of sufficient clarity for processing the Identifying Images.
7. A novel computer program (“Program”), executing on the the Remote Controller, that performs relevant functions, including:
   (A) Uses the Identifying Image on the Electronics Unit to determine which Container is being imaged.
   (B) Communicates via BlueTooth, WiFi, or other means with a Container to lock and unlock it and to verify its current contents and status.
   (C) Uses the Identifying Image on the Electronics Unit to manipulate the image to allow flexibility in Camera position and orientation. If no Electronics Unit is installed in the embodiment, an Identifying Image in a known location on the Cover can be captured by the Remote Controller when the Cover is closed. The Identifying Image enables the Remote Controller to compute its distance, angle, and the three dimensional position relative to the Container and supplement the yaw, pitch, and roll information derived internally by the Remote Controller.
   (D) Triggers the camera (and light, if needed) to capture an image.
   (E) Finds and decodes the Identifying Images in the captured image and then translates them into an item identification scheme with which the operator is familiar (e.g., apartment number).
   (F) Directs the operator to the location of a specific Identifying Image by processing a stream of images while the Remote Controller is moving and displaying the location of the specific Identifying Image as an overlay on the image of the container on the screen.
   (G) Compares images to record and report changes in the contents of the Container.
   (H) Transfers information to and from a relevant data base.
   (I) Security
      (i) Restricts access to the Program and possibly a Container by means of a fingerprint reader, password, or other means.
      (ii) May require the ad hoc rearrangement of Identifying Images to frustrate potential image substitution or to access time.
      (iii) Monitors the amount of time between unlocks and locks of a Secure Container and reports intervals in excess of defined limits.
   (J) Provides safe storage, analysis, and retrieval of the images and/or information decoded from them.

Example uses of the invention are:

1. Dispensing a particular type of item such as a box of aspirin from a secure medicine storage cabinet that contains several boxes of aspirin along with other types of medications. A nurse uses a smartphone equipped with a fingerprint reader and a camera to gain access to the system through finger print identification. The nurse enters a request for a bottle of aspirin, which is relayed by Bluetooth communications to a secure Container. Once the nurse scans the Container's Identifying Image and the program confirms that this is the correct Container, the Container's processor unlocks the Cover. After opening the Cover, the nurse holds the smartphone over the open Container while the program uses the Electronic Unit's Identifying Image and the Identifying Image for aspirin on a label attached to the aspirin box as a guide to direct the nurse's smartphone to the location of one of the boxes of aspirin, and then the Program highlights the location on the smartphone's screen. Once the box of aspirin is retrieved, the nurse closes the Cover, which is detected by the Container, which locks the Cover and signals to the smart phone that a new image is required. The Nurse hovers the smartphone over the locked Container and an image is automatically captured by the smartphone. The smartphone processes the image and compares it to the prior image to determine that indeed one box of aspirin has been removed. That information, along with the time and operator ID are recorded in the system.

2. Returning a door key to a secure Container in a multiple container scenario. A dog walker who had previously checked out an apartment key, returns the key to the concierge. The key is attached to a Tag Holder, which has the Identifying Image on it. The concierge uses a password to sign into the system because his smartphone does not have a finger print reader. He then indicates on the smartphone that he is returning an unknown key, at which point the Program determines which of two Containers (based on available space) should receive the key. Alternatively, the Tag Holder could be color coded and the color information entered into the smartphone if the concierge wished to keep the key in its originally assigned container. The concierge holds his smartphone over the container, and once it finds that the Identifying Image matches the intended container, the program unlocks the Cover. The concierge is then directed by his smartphone, which is reading the Identifying Images to guide him to the location where the Program wishes for him to store the key. After closing the Cover, and taking a new image, the smartphone compares images and confirms that one key was added and that none was moved or removed.

1. A system for monitoring items comprising image-based, encoded tags, a container of known size and shape, an optional cover or door for securing the contents of the container, an image capture and display device, and a program for identifying encoded tags in images.

2. A system for monitoring items as said in claim 1 comprising encoded tags (a) uniquely associated with specific items stored together in a container or (b) uniquely associated with specific groups of items using the same tag

3. A system for monitoring items as said in claim 2 that uses a single image to capture the entire current contents of the container and then processes this image to produce a list of the contents.

4. A system for monitoring items as said in claim 3 comprising a smartphone or other intelligent camera to capture in a single image the container and all of the tags residing in it.

5. A system for monitoring items as said in claim 4 that compares a single image captured before working with the container with a single image captured after working with the container but before working with the container again in order to record the addition, re-arrangement, removal, and count of said tags.

6. A system for monitoring items as said in claim 5 that uses a smartphone or other intelligent camera to indicate—without indicator lights or human-readable designations on or within the container, the location of a desired item in the container.

7. A system for monitoring items as said in claim 6 that uses a smartphone or other intelligent camera to indicate on an image of the container appearing on a screen the location of a desired item.

8. A system for monitoring items as said in claim 7 that uses commonly available tamper evident methods to associate said tags with said items.

9. A system for monitoring items as said in claim 8 that employs an electronic latch to secure a cover and thus the contents of the container.

10. A system for monitoring items as said in claim 9 that comprises sensors to recognize whether the cover or door is closed and the latch is activated and reports this information through the Electronics Unit to the Remote Device.
